(19) United States
(12) Patent Application Publication
(10) Pub. No.: US 2023/0408897 A1
(43) Pub. Date: Dec. 21, 2023

(54) WAVELENGTH CONVERSION MEMBER AND METHOD FOR MANUFACTURING THE SAME, LIGHT-EMITTING DEVICE, AND PROJECTOR

(71) Applicant: NICHIA CORPORATION, Anan-shi (JP)

(72) Inventor: Eri YOSHIDA, Anan-shi (JP)

(73) Assignee: NICHIA CORPORATION, Anan-shi (JP)

(21) Appl. No.: 18/334,245

(22) Filed: Jun. 13, 2023

(30) Foreign Application Priority Data
Jun. 15, 2022 (JP) 2022-096431
Dec. 13, 2022 (JP) 2022-198516

(51) Int. Cl. G03B 21/20; G02B 26/00

(52) U.S. Cl. CPC G03B 21/204; G02B 26/008; G03B 21/2066; C09K 11/02

(57) ABSTRACT

A wavelength conversion member includes a substrate and a wavelength conversion layer containing a binder and a phosphor and disposed on the substrate. The wavelength conversion layer has a volume ratio of the phosphor to the binder in a range of 0.75 to 1.45 and an average thickness in a range of 55 μm to 146 μm. A method for manufacturing a wavelength conversion member includes applying a phosphor composition onto a substrate, the phosphor composition including a binder, a solvent, and a phosphor, a boiling point of the solvent being in a range of 200° C. to 300° C., a mass ratio of the solvent to the binder being in a range of 0.01 to 0.4, and a mass ratio of the phosphor to the binder being in a range of 3.15 to 6.05, and heat-treating the phosphor composition applied onto the substrate to form a wavelength conversion layer.

### CROSS-REFERENCE TO RELATED APPLICATION

This application claims priority to Japanese Patent Application No. 2022-096431 filed on Jun. 15, 2022, and Japanese Patent Application No. 2022-198516 filed on Dec. 13, 2022, the disclosures of which are hereby incorporated by reference in their entireties.

### BACKGROUND

The present disclosure relates to a wavelength conversion member and a method for manufacturing the wavelength conversion member, a light-emitting device, and a projector.

In an image projection apparatus (projector) in which light emitted from a light-emitting device is projected on a screen by a micromirror display element or the like to display a color image, high output of the light-emitting device is required. For example, International Publication WO 2018/198949 proposes a light-emitting device including a wavelength conversion element having high conversion efficiency from excitation light to fluorescence.

### SUMMARY

An objective of an aspect of the present disclosure is to provide a wavelength conversion member that can form a light-emitting device having high light emission efficiency, a method for manufacturing the wavelength conversion member, a light-emitting device, and a projector.

A first aspect is a wavelength conversion member including a substrate, and a wavelength conversion layer disposed on the substrate and containing a binder and a phosphor. The wavelength conversion layer has a volume ratio of the phosphor to the binder in a range of 0.75 to 1.45 and an average thickness in a range of 55 μm to 146 μm.

A second aspect is a wavelength conversion member including a substrate, and a wavelength conversion layer disposed on the substrate and containing a binder and a phosphor. In the wavelength conversion layer, in a cross section orthogonal to an arrangement surface of the wavelength conversion layer on the substrate, a ratio of a sum of a particle cross-sectional area of the phosphor to a cross-sectional area of the wavelength conversion layer is in a range of 56% to 70%, and an average thickness of the wavelength conversion layer is in a range of 55 μm to 146 μm.

A third aspect is a light-emitting device including the wavelength conversion member according to the first aspect or the second aspect, a motor configured to rotate the wavelength conversion member, and a light source configured to irradiate the wavelength conversion member with light. A fourth aspect is a projector including the light-emitting device according to the third aspect, an image display system, and a projection optical system.

A fifth aspect is a method for manufacturing a wavelength conversion member, the method including: applying a phosphor composition onto a substrate, the phosphor composition including a binder, a solvent, and a phosphor, a boiling point of the solvent being in a range of 200° C. to 300° C., a mass ratio of the solvent to the binder being in a range of 0.01 to 0.4, and a mass ratio of the phosphor to the binder being in a range of 3.15 to 6.05; and heat-treating the phosphor composition applied onto the substrate to form a wavelength conversion layer.

According to one or more aspects of the present disclosure, it is possible to provide a wavelength conversion member that can form a light-emitting device having high light emission efficiency, a method for manufacturing the wavelength conversion member, a light-emitting device, and a projector.

### BRIEF DESCRIPTION OF DRAWINGS

FIG. 1 is a schematic configuration diagram illustrating an example of a configuration of a light-emitting device.

FIG. 2 is a schematic configuration diagram illustrating an example of a configuration of a projector.

FIG. 3A is a schematic cross-sectional view illustrating an example of a configuration of a wavelength conversion member.

FIG. 3B is a schematic perspective view illustrating an example of the configuration of the wavelength conversion member.

FIG. 3C is a schematic plan view illustrating an example of the configuration of the wavelength conversion member.

### DESCRIPTION OF EMBODIMENT

The word “step” herein is included in the present terminology if the anticipated purpose of the step is achieved in the case of not only an independent step, but also a step that cannot be clearly distinguished from another step. If a plurality of substances applicable to each component in a composition are present, the content of each component in the composition means the total amount of the plurality of substances present in the composition, unless otherwise specified. Furthermore, with respect to an upper limit and a lower limit of numerical ranges described herein, the numerical values exemplified as the numerical range can be freely selected and combined. In the present specification, in a formula representing a composition of a phosphor or a light-emitting material, a plurality of elements separated by a comma (,) means that at least one of the plurality of elements is contained in the composition. In the formulae expressing the composition of the phosphor, the characters preceding the colon (:) represent a host crystal, and the characters following the colon (:) represent an activating element. Note that herein, relationships such as the relationship between a color name and a chromaticity coordinate, the relationship between a wavelength range of light and a color name of monochromatic light are in accordance with JIS Z8110. The full width at half maximum of the phosphor means a wavelength width (full width at half maximum; FWHM) of an emission spectrum in which the emission intensity is 50% with respect to the maximum emission intensity in the emission spectrum of the phosphor. Embodiments of the present invention will be described below in detail. However, the embodiments described below exemplify, for embodying the technical idea of the present invention, a wavelength conversion member, a method for manufacturing the wavelength conversion member, a light-emitting device, and a projector, and the present invention is not limited to the wavelength conversion member, the method for manufacturing the wavelength conversion member, the light-emitting device, and the projector described below.

### Wavelength Conversion Member

A wavelength conversion member according to a first aspect includes a substrate, and a wavelength conversion layer disposed on the substrate and containing a binder and a phosphor. The wavelength conversion layer has a volume ratio of the phosphor to the binder in a range of 0.75 to 1.45 and an average thickness in a range of 55 μm to 146 μm.

The light emission efficiency of a light-emitting device including a light source, a wavelength conversion member, and an optical system including, for example, a lens and a reflecting mirror, is evaluated by total efficiency which is a product of fluorescence efficiency in the wavelength conversion member and light collection efficiency in the optical system. That is, the total efficiency of the light-emitting device means the light emission efficiency of the light-emitting device as a whole. Fluorescence efficiency corresponds to wavelength conversion efficiency of the wavelength conversion member, and is evaluated as a ratio of intensity of light emitted from the wavelength conversion layer to intensity of light incident from the light source. The light collection efficiency corresponds to efficiency with which the light emitted from the wavelength conversion member is taken into the optical system, and is evaluated as a ratio of the intensity of light output from the optical system to the intensity of the light emitted from the wavelength conversion layer.

The wavelength conversion member, in which the wavelength conversion layer having a volume ratio of the phosphor to the binder contained in the wavelength conversion layer in a range of 0.75 to 1.45 and an average thickness in a range of 55 μm to 146 μm is disposed on a substrate, can achieve higher fluorescence efficiency when the wavelength conversion member is combined with the light source to form the light-emitting device. This can be thought, for example, as follows. Because the volume ratio of the phosphor contained in the wavelength conversion layer is high, the fluorescence efficiency in the wavelength conversion layer is high, and spread of the light extracted from the wavelength conversion layer is suppressed, so that the light collection efficiency is high, and the total efficiency as the light-emitting device is improved. Further, when the thickness of the wavelength conversion layer is in a predetermined range, the spread of light is suppressed to increase the light collection efficiency, heat dissipation of the wavelength conversion layer is improved, and the increase in surface temperature is suppressed to increase the fluorescence efficiency. It is considerable that the total efficiency of the light-emitting device is improved by increasing the fluorescence efficiency and the light collection efficiency as described above.

A wavelength conversion member according to a second aspect includes a substrate, and a wavelength conversion layer disposed on the substrate and containing a binder and a phosphor. The wavelength conversion layer has, in a cross section orthogonal to an arrangement surface of the wavelength conversion layer on the substrate, a ratio of a sum of a particle cross-sectional area of the phosphor to a cross-sectional area of the wavelength conversion layer in a range of 56% to 70%, and an average thickness in a range of 55 μm to 146 μm.

The wavelength conversion member, in which the wavelength conversion layer having, in the cross section of the wavelength conversion layer, the ratio of the sum of the particle cross-sectional area of the phosphor to the cross-sectional area of the wavelength conversion layer in a range of 56% to 70% and an average thickness in a range of 55 μm to 146 μm is disposed on the substrate, can achieve higher fluorescence efficiency when the wavelength conversion member is combined with the light source to form the light-emitting device. This can be thought, for example, as follows. Because the volume ratio of the phosphor contained in the wavelength conversion layer is high, the fluorescence efficiency in the wavelength conversion layer is high, and spread of the light extracted from the wavelength conversion layer is suppressed, so that the light collection efficiency is high, and the total efficiency as the light-emitting device is improved. Further, when the thickness of the wavelength conversion layer is in a predetermined range, the spread of light is suppressed to increase the light collection efficiency, heat dissipation of the wavelength conversion layer is improved, and the increase in surface temperature is suppressed to increase the fluorescence efficiency. It is considerable that the total efficiency of the light-emitting device is improved by increasing the fluorescence efficiency and the light collection efficiency as described above.

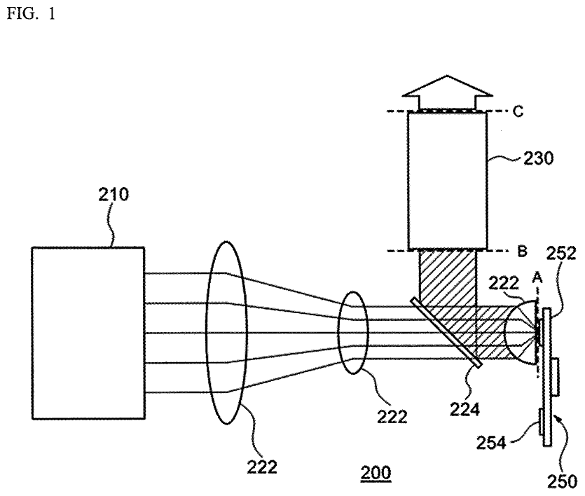

Here, a method for evaluating the fluorescence efficiency and the light collection efficiency will be described with reference to the drawings. FIG. 1 is a schematic configuration diagram illustrating an example of a light-emitting device. A light-emitting device 200 includes a light source 210, a lens 222 that collects light from the light source 210 on a wavelength conversion member 250, and a dichroic mirror 224 that reflects output light from the wavelength conversion member 250 and directs the direction of the output light to a lens system 230. The wavelength conversion member 250 includes a disk-shaped substrate 252 and a wavelength conversion layer 254 containing a phosphor and a binder. The wavelength conversion layer 254 is disposed, for example, in an annular shape along the circumference of the substrate 252. The fluorescence efficiency of the light-emitting device 200 is calculated by dividing fluorescence output measured by a power meter at a position B by excitation output measured by a power meter at a position A. The light collection efficiency is calculated by dividing emission output measured by a power meter at a position C by the fluorescence output measured by the power meter at the position B. The total efficiency of the light-emitting device 200 is calculated as the product of the fluorescence efficiency and the light collection efficiency, and corresponds to a value obtained by dividing the emission output by the excitation output. In the evaluation of the fluorescence efficiency, the surface temperature of the wavelength conversion layer 254 may be measured by infrared thermography to confirm that the increase in the surface temperature is suppressed.

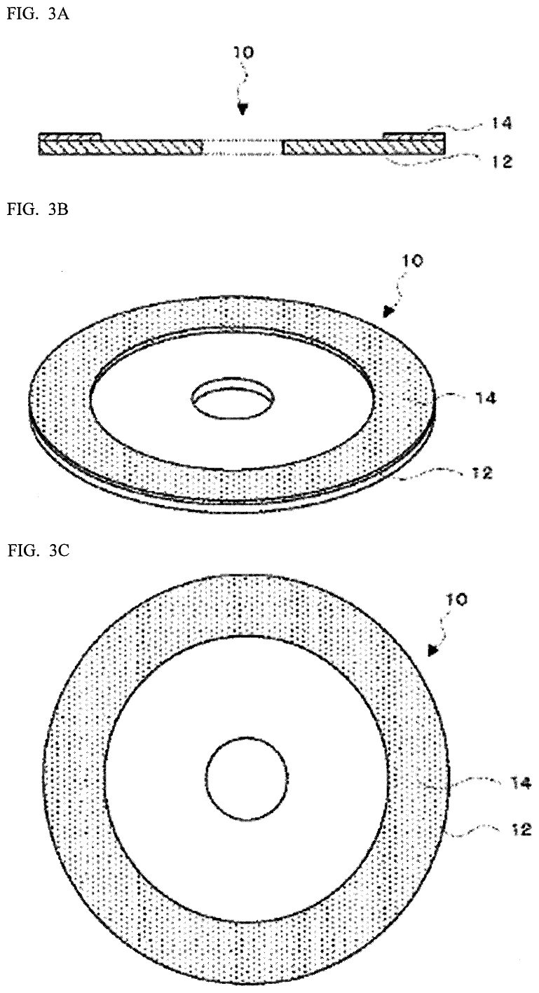

The wavelength conversion member includes the substrate and the wavelength conversion layer disposed on the substrate. Here, an example of the configuration of the wavelength conversion member will be described with reference to the drawings. FIG. 3A is a schematic cross-sectional view illustrating an example of a configuration of the wavelength conversion member. FIG. 3B is a schematic perspective view illustrating an example of the configuration of the wavelength conversion member. FIG. 3C is a schematic plan view illustrating an example of the configuration of the wavelength conversion member. In a wavelength conversion member 10, a phosphor layer 14 is formed on a substrate 12. In FIG. 3 to FIG. 3C, the substrate 12 has a disk-like shape. The phosphor layer 14 is disposed in an annular shape along the circumference of the substrate 12. The wavelength conversion member 10 absorbs excitation light emitted from the light source, generates converted light having a wavelength different from that of the excitation light, and emits the converted light. For example, the wavelength conversion member 10 may absorb blue light from the light source, emit converted light having a wavelength different from that of the blue light converted by the phosphor layer 14, reflect the blue light, and emit mixed color light of the converted light and the blue light, or may emit only the converted light. The wavelength conversion member can convert the excitation light from the light source into light of various colors.

The substrate forming the wavelength conversion member is not limited to a disk-like shape, and may have a shape such as a polygonal plate shape. The thickness of the substrate may be, for example, in a range of 0.1 mm to 1 mm, and preferably in a range of 0.4 mm to 0.6 mm.

The substrate may be a metal member containing a metal material such as aluminum, iron, copper, silver, nickel, or stainless steel. When the substrate is a metal member containing a metal material, light incident on the wavelength conversion member can be wavelength-converted by the wavelength conversion layer and reflected to the same side as the surface on which the light is incident. In addition, because heat dissipation from the phosphor is further improved, the fluorescence efficiency of the wavelength conversion member can be increased.

Alternatively, the substrate may be a light-transmissive member containing a light-transmissive material such as glass or aluminum oxide. When the substrate is a light-transmissive member, light incident on the wavelength conversion member can be wavelength-converted by the wavelength conversion layer and emitted to the side opposite from the surface on which the light is incident. Of the light-transmissive member, the main surface on which the wavelength conversion layer is formed and/or the other opposing main surface may be preliminarily roughened through etching, laser machining, or the like, for example. Consequently, uneven light emission at the light-emitting surface of the wavelength conversion member can be suppressed.

At least a part of the surface of the substrate may be a reflective surface. The reflective surface may be formed at least in a region where the wavelength conversion layer is disposed. The reflective surface may be formed of, for example, a material containing at least one selected from the group consisting of silver and aluminum. The reflective surface of the substrate may be formed from the material of the substrate itself. That is, the substrate itself may be formed of, for example, a material containing at least one selected from the group consisting of silver and aluminum, and at least a part of the surface of the substrate may be the reflective surface. Alternatively, the reflective surface may be formed by a surface of the reflective layer disposed on the substrate. Examples of the material for forming the reflective layer include silver, aluminum, an alloy containing at least one selected therefrom, and a resin containing a metal oxide such as titanium oxide. The specular reflectance of the reflective surface may be, for example, 80% or more, preferably 85% or more, or 90% or more. The upper limit of the specular reflectance may be, for example, 100% or less. When the specular reflectance of the reflective surface is 80% or more, there is a tendency that the extraction amount of light can be further increased. The specular reflectance of the reflective surface of the substrate is measured using light of a wavelength 450 nm.

The wavelength conversion layer disposed on the substrate may contain the binder and the phosphor. The binder included in the wavelength conversion layer may be an organic binder or an inorganic binder. The organic binder may contain a cured product of a resin, and preferably a cured product of a light-transmissive resin. Examples of the resin include thermosetting resins such as an epoxy resin, a silicone resin, an epoxy-modified silicone resin, and a modified silicone resin. When the resin contains a silicone resin, heat resistance, light resistance, and the like tend to become better. The silicone resin or the modified silicone resin may contain at least one selected from the group consisting of a phenyl silicone resin, a modified phenyl silicone resin, a dialkyl silicone resin, and a modified dialkyl silicone resin. Examples of the inorganic binder include glass, ceramics, and aluminum oxide.

The content of the binder in the wavelength conversion layer may be, for example, 10% by mass or more and 25% by mass or less, preferably 12% by mass or more, or 14% by mass or more, and less than 25% by weight, 23% by weight or less, or 20% by weight or less, with respect to the total weight of the wavelength conversion layer.

The phosphor included in the wavelength conversion layer may contain, for example, at least one of rare earth aluminate phosphors. The rare earth aluminate phosphor may have, for example, a composition including at least one first element selected from the group consisting of yttrium, lanthanum, lutetium, gadolinium, and terbium; at least one second element selected from the group consisting of aluminum, gallium, and scandium, the second element including at least aluminum; and cerium. In the composition of the rare earth aluminate phosphor, for example, when the total number of moles of the second element is 5 moles, the molar content ratio of the first element to the total number of moles of the second element may be, for example, in a range of 2.5 to 3.5, and preferably in a range of 2.8 to 3.2. When the total number of moles of the second element is 5 moles, the molar content ratio of oxygen atoms the total number of moles of the second element may be, for example, in a range of 10 to 14, and preferably in a range of 11 to 13. The molar content ratio of aluminum to the total number of moles of the second element may be, for example, more than 0 and 1 or less, and may be preferably in a range of 0.4 to 1.0. The second element in the composition of the rare earth aluminate phosphor may be partially substituted with at least one selected from the group consisting of silicon and germanium. The rare earth aluminate phosphor may have, for example, a theoretical composition represented by the following formula (1).

(Y,Lu,Gd)₃(Ga,Al)₅O₁₂:Ce (1)

The rare earth aluminate phosphor may have a composition different from the theoretical composition as long as emission characteristics substantially equivalent to those of the theoretical composition represented by the formula (1) are obtained. For example, the rare earth aluminate phosphor may have a composition represented by the following formula (1a).

(Y,Lu,Gd)ᵢ(Ga,Al)₅Oⱼ:Ce (1a)

In the formula (1a), i and j may satisfy 2.5≤i≤3.5 and 10≤j≤14, and preferably satisfy 2.8≤i≤3.2 and 11≤j≤13.

The emission peak wavelength of the rare earth aluminate phosphor may be, for example, in a range of 450 nm to 580 nm, and preferably 490 nm or more, 500 nm or more, 520 nm or more, or 550 nm or more. The upper limit of the emission peak wavelength may be preferably 575 nm or less, 570 nm or less, or 560 nm or less. In addition, the full width at half maximum width may be, for example, in a range of 80 nm to 150 nm, is preferably 90 nm or more, 100 nm or more, or 110 nm or more, and preferably 140 nm or less, 130 nm or less, or 125 nm or less.

The median particle diameter of the phosphor may be, for example, in a range of 15 m to 40 μm, preferably 17 μm or more, 20 μm or more, 22 μm or more, or 24 μm or more, and preferably 35 μm or less, 33 μm or less, or 31 μm or less. When the median particle diameter of the phosphor is within the above range, a wavelength conversion member having higher fluorescence efficiency tends to be obtained. The median particle diameter of the phosphor means a volume average particle diameter (median diameter), and is a particle diameter corresponding to a volume cumulative frequency of 50% from the small diameter side in a volume cumulative particle size distribution. The volume average particle diameter is measured by using, for example, a laser diffraction particle size distribution analyzer.

The particle size distribution of the phosphor may be, for example, a particle size distribution having a single peak, preferably a particle size distribution having a single peak with a narrow distribution width, from the viewpoint of improving the luminance. Specifically, in the volume-based particle size distribution, when the particle size corresponding to 10% volume accumulation from the small diameter side is D₁₀, and the particle size corresponding to 90% volume accumulation is D₉₀, the ratio of D₉₀ to D₁₀ (D₉₀/D₁₀) may be, for example, 3.0 or less.

The concentration of the phosphor may be, for example, in a range of 4 g/cm³ to 7 g/cm³, preferably 4.5 g/cm³ or more, and preferably 6.9 g/cm³ or less, 6 g/cm³ or less, or 5 g/cm³ or less.

The wavelength conversion layer may further contain other components in addition to the phosphor and the binder. Examples of the other components include fillers such as silica, barium titanate, titanium oxide, and aluminum oxide, light stabilizers, and colorant. In a case in which the wavelength conversion member contains other components, the content thereof can be appropriately selected according to the purpose or the like. For example, when a filler is contained as the other component, the content thereof can be set in a range of 0.01 parts by mass to 20 parts by mass with respect to 100 parts by mass of the binder.

The mass ratio of the phosphor to the binder contained in the wavelength conversion layer may be, for example, in a range of 3.15 to 6.05, preferably 3.5 or more, 3.8 or more, or 4 or more, and preferably 6 or less.

The volume ratio of the phosphor to the binder contained in the wavelength conversion layer may be, for example, in a range of 0.75 to 1.45, preferably 0.8 or more, 0.84 or more, 0.88 or more, 0.94 or more, or 0.96 or more, and preferably 1.44 or less, 1.43 or less, 1.2 or less, or 1.0 or less. When the volume ratio of the phosphor to the binder is within the above range, the total efficiency of the light-emitting device tends to be further improved. Here, the volume ratio of the phosphor to the binder contained in the wavelength conversion layer is calculated by dividing the area occupied by the phosphor by the area occupied by the resin in a discretionally cross section of the wavelength conversion layer. Here, the area occupied by the resin is calculated by, for example, subtracting the area occupied by the phosphor from the area of the wavelength conversion layer. In addition, the discretionally cross section of the wavelength conversion layer may be a cross section intersecting with the substrate on which the wavelength conversion layer is disposed.

The volume ratio of the phosphor to the binder contained in the wavelength conversion layer may be approximately calculated as a ratio of the volume of the phosphor to the volume of the binder contained in the phosphor composition forming the wavelength conversion layer. Here, the volume of the binder is calculated by dividing the mass of the binder contained in the phosphor composition by the density of the binder. The volume of the phosphor is calculated by dividing the mass of the phosphor contained in the phosphor composition by the density of the phosphor.

In a cross section orthogonal to the surface of the wavelength conversion layer disposed on the substrate, the ratio of the sum of the particle cross-sectional area of the phosphor to the cross-sectional area of the wavelength conversion layer (hereinafter, also referred to as “cross-sectional ratio”) may be, for example, in a range of 56% to 70%. The cross-sectional ratio may preferably be 58% or more, 60% or more, 61% or more, or 62% or more. The cross-sectional ratio may be 68% or less, 66% or less, 65% or less, or 64% or less. When the cross-sectional ratio is in the above range, the emission intensity of the output light tends to be further improved. Here, the sum of the particle cross-sectional area of the phosphor is the sum of the cross-sectional area of the individual phosphor particle observed in the cross section of the wavelength conversion layer.

The cross-sectional ratio is calculated, for example, as follows. In the cross section of the wavelength conversion layer orthogonal to the main surface of the substrate on which the wavelength conversion layer is disposed, a region having a predetermined lateral width (for example, 640 μm) is discretionally selected. With respect to the vertical width of the wavelength conversion layer, two parallel lines orthogonal to the thickness direction of the wavelength conversion layer are used, the straight parallel lines are visually adjusted so as to respectively coincide with the upper surface and the lower surface of the wavelength conversion layer, and the vertical width of the wavelength conversion layer is measured as the distance between the two straight lines. By multiplying the predetermined lateral width of the wavelength conversion layer by the vertical width of the wavelength conversion layer, the cross-sectional area of the wavelength conversion layer to be measured is calculated.

The sum of the particle cross-sectional area of the phosphor is calculated as the sum of the cross-sectional area of each phosphor particle observed in the cross section of the wavelength conversion layer to be measured. The cross-sectional area of each phosphor particle in the cross section of the wavelength conversion layer is measured as a cross-sectional area of a particle identified as a phosphor particle in a reflected electron image obtained by observing the cross section of the wavelength conversion layer to be measured with a scanning electron microscope (SEM). The sum of the calculated particle cross-sectional area of the phosphor is divided by the cross-sectional area of the wavelength conversion layer to calculate the cross-sectional ratio.

The average thickness of the wavelength conversion layer may be, for example, in a range of 55 μm to 146 μm, preferably 60 μm or more, or 75 μm or more, and preferably 145 μm or less, 140 μm or less, or 120 μm or less. When the average thickness of the wavelength conversion layer is within the above range, the total efficiency of the light-emitting device tends to be further improved. The thickness of the wavelength conversion layer is calculated by subtracting the arithmetic average value of the thickness of the substrate from the arithmetic average value of the total thickness of the wavelength conversion layer and the substrate. Each of the arithmetic average value of the total thickness of the wavelength conversion layer and the substrate and the arithmetic average value of the thickness of the substrate is calculated from the measured values at discretional six points. The total thickness of the wavelength conversion layer and the substrate and the thickness of the substrate are measured by, for example, a contact-type thickness measuring device.

The wavelength conversion layer may have a substantially uniform thickness. A variation coefficient of the thickness of the wavelength conversion layer may be, for example, 0.4 or less, and preferably 0.3 or less. The lower limit of the variation coefficient of the thickness of the wavelength conversion layer may be, for example, 0.09 or more. The variation coefficient of the thickness of the wavelength conversion layer is calculated by dividing the standard deviation of the thickness of the wavelength conversion layer by the average thickness of the wavelength conversion layer.

In an aspect, the wavelength conversion member may include a disk-shaped substrate having a reflective surface, and a wavelength conversion layer disposed in an annular shape along a circumference of the substrate on the reflective surface of the substrate.

### Method for Manufacturing Wavelength Conversion Member

The method for manufacturing a wavelength conversion member may include an application step of applying a phosphor composition containing a binder, a solvent, and a phosphor onto a substrate, and a heat treatment step of heat-treating the phosphor composition applied onto the substrate to form a wavelength conversion layer. The solvent included in the phosphor composition may have a boiling point of in a range of 200° C. to 300° C. In the phosphor composition, the mass ratio of the solvent to the binder may be in a range of 0.01 to 0.4, and the mass ratio of the phosphor to the binder may be in a range of 3.15 to 6.05.

When the phosphor composition for forming the wavelength conversion layer contains a specific content of solvent having a specific boiling point, a wavelength conversion layer having a desired average thickness can be efficiently formed with high productivity even when the content of the phosphor is high. Because the wavelength conversion layer to be formed has a high content of the phosphor and a predetermined average thickness, a light-emitting device including the wavelength conversion member can achieve good total efficiency.

The phosphor composition contains at least the binder, the solvent, and the phosphor. The binder contained in the phosphor composition may be an organic binder or an inorganic binder. The organic binder may contain, for example, a resin, and preferably a light-transmissive resin. Examples of the resin include thermosetting resins such as an epoxy resin, a silicone resin, an epoxy-modified silicone resin, and a modified silicone resin. When the resin material contains a silicone resin, heat resistance, light resistance, and the like tend to be better. The silicone resin or the modified silicone resin may contain at least one selected from the group consisting of a phenyl silicone resin, a modified phenyl silicone resin, a dialkyl silicone resin, and a modified dialkyl silicone resin. Examples of the inorganic binder include glass, ceramics, and aluminum oxide.

The phosphor contained in the phosphor composition may contain, for example, at least one of rare earth aluminate phosphors. The details of the rare earth aluminate phosphor are as described above. The content of the phosphor in the phosphor composition, as a mass ratio to the binder, may be, for example, in a range of 3.15 to 6.05, preferably 3.5 or more, or 4 or more, and preferably 6 or less. When the content of the phosphor is within the above range, the total efficiency of the light-emitting device tends to be higher.

The solvent contained in the phosphor composition may have, for example, a boiling point of in a range of 200° C. to 300° C., preferably 210° C. or more, or 230° C. or more, and preferably 280° C. or less, 260° C. or less, or 250° C. or less. When the boiling point of the solvent is within the above range, the workability in the application step tends to be further improved. From the viewpoint of the solubility of the binder, the solvent may contain, for example, an aliphatic hydrocarbon-based solvent, and may contain at least one selected from the group consisting of aliphatic hydrocarbon-based solvents having a range of 12 to 16 carbon atoms. The solvent may preferably contain at least one selected from the group consisting of dodecane (boiling point 216° C.), tridecane (boiling point 234° C.), tetradecane (boiling point 254° C.), pentadecane (boiling point 271° C.) and hexadecane (boiling point 287° C.).

The content of the solvent in the phosphor composition may be, as a mass ratio of the solvent to the binder, for example, in a range of 0.01 to 0.4, preferably 0.02 or more, 0.04 or more, or 0.05 or more, and preferably 0.38 or less, 0.35 or less, 0.3 or less, 0.2 or less, or 0.1 or less. The content of the solvent in the phosphor composition may be, for example, 0.002 or more and 0.06 or less, and preferably 0.01 or more or 0.05 or less, as a mass ratio of the solvent to the total mass of the binder and the phosphor. When the content of the solvent is within the above range, the workability in the application step tends to be further improved.

The phosphor composition can be provided by, for example, mixing a binder, a solvent, and a phosphor. Alternatively, the phosphor composition may be provided by mixing a mixture of a binder and a solvent with a phosphor. The mixing method can be appropriately selected from generally used mixing methods, and examples of the mixing method include a method using a vacuum defoaming mixer, a stirring apparatus, or the like.

In the application step, the phosphor composition is applied to the substrate. Details of the substrate to which the phosphor composition is applied are as described above. The phosphor composition may preferably be applied onto the reflective surface of the substrate. Examples of the method for applying the phosphor composition to the substrate include a printing method, a coating method, and adhesion of a phosphor composition sheet. The method of applying the phosphor composition to the substrate may preferably be a printing method.

The application of the phosphor composition by the printing method can be performed by, for example, screen printing in which a screen plate is disposed at a desired position of the substrate, and a squeegee is moved on the disposed screen plate to allow the phosphor composition to pass through the screen plate, thereby forming a phosphor composition layer having a predetermined thickness on the substrate. This makes it possible to apply the phosphor composition onto the substrate with a substantially uniform thickness. In addition, the thickness of the phosphor composition layer to be formed can be adjusted by using a screen plate in which a fiber diameter, linearity, a mesh screen thickness, an aperture ratio, a number of meshes, and the like of the fibers forming the screen are appropriately adjusted. The thickness of the phosphor composition layer formed on the substrate may be appropriately adjusted according to the thickness of the target wavelength conversion layer. In addition, the application amount of the phosphor composition is an application amount such that the wavelength conversion layer to be formed has a desired thickness. The average thickness of the wavelength conversion layer to be formed may be, for example, in a range of 55 μm to 146 μm, preferably 60 μm or more, or 75 μm or more, and preferably 145 μm or less, 140 μm or less, or 120 μm or less.

In the heat treatment step, the phosphor composition applied onto the substrate is heat-treated to form the wavelength conversion layer. The heat treatment step may include thermally curing the binder contained in the phosphor composition to form the wavelength conversion layer. The heat treatment temperature in the heat treatment step may be appropriately set according to the thermosetting properties of the binder. The heat treatment temperature may be, for example, a temperature lower than the boiling point of the solvent contained in the phosphor composition. This makes it possible to suppress the formation of voids or the like due to the volatilization of the solvent. The heat treatment temperature may be, for example, in a range of 50° C. to 180° C., and preferably in a range of 100° C. to 150° C. The heat treatment time may be, for example, in a range of 1 hour to 10 hours, and preferably 4 hours or more, or 8 hours or less. The atmosphere of the heat treatment may be, for example, an air atmosphere.

In the heat treatment step, at least a part of the solvent contained in the phosphor composition may be removed prior to the thermal curing of the binder. The removal of the solvent can be performed by, for example, heating or reducing the pressure of the phosphor composition. When the solvent is removed by heating, the temperature may be, for example, in a range of 50° C. to 180° C., preferably 100° C. or more, or 150° C. or less. The removal time of the solvent may be, for example, in a range of 1 hour to 10 hours, and preferably 4 hours or more or 8 hours or less.

### Light-Emitting Device

The light-emitting device includes the wavelength conversion member according to the first aspect, a motor that rotates the wavelength conversion member, and a light source that irradiates the wavelength conversion member with light. The light-emitting device emits mixed color light of light from the light source and light from the wavelength conversion member irradiated with the light from the light source. The light-emitting device including the wavelength conversion member having a specific configuration can achieve good total efficiency. The details of the wavelength conversion member forming the light-emitting device are as described above.

In the light-emitting device, the wavelength conversion member is fixed to a rotation shaft of the motor to be rotatable by the motor. Examples of the light source that irradiates the wavelength conversion member with light include a light-emitting element. The light-emitting element may be a semiconductor light-emitting element, and may be a light-emitting diode or a laser diode. The light-emitting element forming the light source may be of one type alone, or may be a combination of two or more types. Further, the light source may include single light-emitting element or a plurality of light-emitting elements.

The light source may have an emission peak wavelength in a range of wavelengths from 440 nm to 470 nm, for example. The emission peak wavelength of the light source may preferably be in a range of wavelengths from 450 nm to 460 nm. The full width at half maximum of the light sources may be 30 nm or less, for example.

The output of the light sources may be, for example, 0.5 W/mm² or more, and preferably 5 W/mm² or more, or 10 W/mm² or more as the optical power density with which the wavelength conversion member is irradiated. The upper limit of the output of the light-emitting element may be, for example, 1000 W/mm² or less, and is preferably 500 W/mm² or less, or 150 W/mm² or less.

The light-emitting device can constitute, for example, a projector described below. A high-output projector can be configured by using a light-emitting device with good total efficiency. The light-emitting device can be used not only as a light source device for a projector, but also as a light-emitting device provided in a light source of an general lighting apparatus such as a ceiling light; a special lighting apparatus such as a spotlight, stadium lighting, or studio lighting; a vehicle illuminating apparatus such as a headlamp; a projection device such as a head-up display; an imaging device such as light for an endoscope, a digital camera, a mobile phone, or a smartphone; and a liquid crystal display device such as a personal computer (PC) monitor, a laptop personal computer, a television, a mobile information terminal (PDX), a smartphone, a tablet PC, or a mobile phone.

### Projector

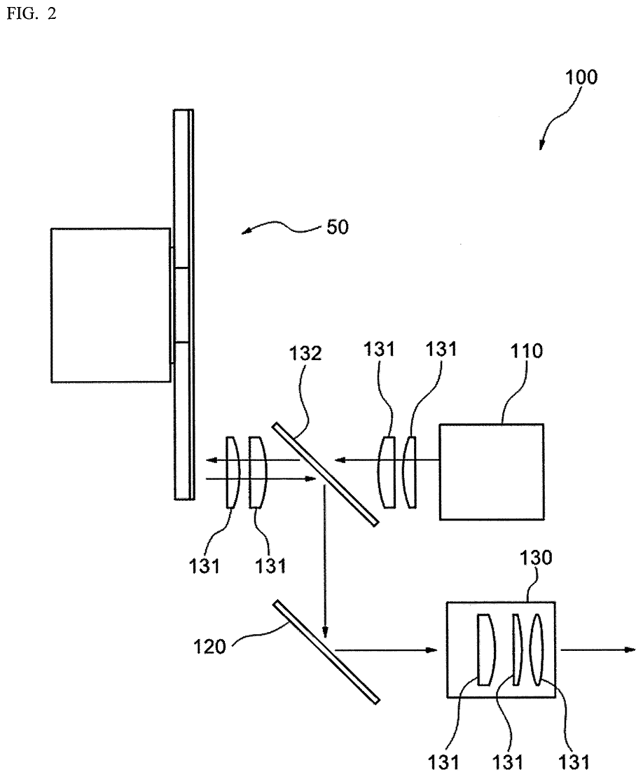

The projector includes the light-emitting device described above, an image display system, and a projection optical system. An example of the configuration of the projector will be described with reference to FIG. 2. FIG. 2 is a schematic configuration diagram of a projector 100. The projector 100 includes a light source 110, a wavelength conversion member 50, an image display system 120, and a projection optical system 130. In the projector 100, the image display system 120 is irradiated with the mixed light of the light from the light source 110 and the light obtained by wavelength-converting the light from the light source 110 by the wavelength conversion member 50. The image display system 120 converts the irradiated light into an image, and projects the image to the outside via the projection optical system 130.

The details of the light source 110 and the wavelength conversion member 50 constituting the projector 100 are as described above. The image display system 120 displays an image projected by the projector 100. As the image display system 120, a liquid crystal panel, a digital mirror device (DMD), or the like can be used. The projection optical system 130 projects, to the outside, an image obtained by converting the light emitted from the wavelength conversion member 50 by the image display system 120. The projection optical system 130 includes a plurality of lenses 131, and can perform zoom, focus adjustment, and the like. The projector 100 is configured by a lens 131, a dichroic mirror 132, and the like in addition to the configuration described above. The projector 100 may further include a mirror, a dichroic mirror, a lens, a prism, and the like, which are not illustrated in FIG. 2, according to the design of the projector 100.

The present disclosure may include the following aspects.

(1) A wavelength conversion member including a substrate, and a wavelength conversion layer disposed on the substrate and containing a binder and a phosphor, where the wavelength conversion layer has a volume ratio of the phosphor to the binder in a range of 0.75 to 1.45 and an average thickness in a range of 55 μm to 146 μm.

(2) A wavelength conversion member including a substrate, and a wavelength conversion layer including a binder and a phosphor and disposed on the substrate, where in a cross section orthogonal to an arrangement surface of the wavelength conversion layer on the substrate, a ratio of a sum of a particle cross-sectional area of the phosphor to a cross-sectional area of the wavelength conversion layer is in a range of 56% to 70%, and an average thickness of the wavelength conversion layer is in a range of 55 μm to 146 μm.

(3) The wavelength conversion member according to (1) or (2), where the phosphor includes a rare earth aluminate phosphor having a composition including: at least one first element selected from the group consisting of yttrium, lanthanum, lutetium, gadolinium, and terbium; at least one second element selected from the group consisting of aluminum, gallium, and scandium, the second element including at least aluminum; and cerium.

(4) The wavelength conversion member according to any one of (1) to (3), where the phosphor has a median particle diameter in a range of 15 μm to 40 μm.

(5) The wavelength conversion member according to any one of (1) to (4), where the substrate has a reflective surface formed of a material containing at least one selected from the group consisting of silver and aluminum, and the wavelength conversion layer is disposed on the reflective surface.

(6) The wavelength conversion member according to any one of (1) to (5), where the binder contains a silicone resin.

(7) A light-emitting device including the wavelength conversion member according to any one of (1) to (6), a motor configured to rotate the wavelength conversion member, and a light source configured to irradiate the wavelength conversion member with light.

(8) A projector including the light-emitting device according to (7), an image display system, and a projection optical system.

(9) A method for manufacturing a wavelength conversion member, the method including: applying a phosphor composition onto a substrate, the phosphor composition including a binder, a solvent, and a phosphor, a boiling point of the solvent being in a range of 200° C. to 300° C., a mass ratio of the solvent to the binder being in a range of 0.01 to 0.4, and a mass ratio of the phosphor to the binder being in a range of 3.15 to 6.05; and heat-treating the phosphor composition applied onto the substrate to form a wavelength conversion layer.

(10) The method for manufacturing a wavelength conversion member according to (9), where the step of applying the phosphor composition onto the substrate includes screen-printing the phosphor composition.

(11) The method for manufacturing a wavelength conversion member according to (9) or (10), where the step of heat-treating the phosphor composition includes performing heat-treatment at less than 200° C.

(12) The method for manufacturing a wavelength conversion member according to any one of (9) to (11), where the phosphor includes a rare earth aluminate phosphor having a composition including: at least one first element selected from the group consisting of yttrium, lanthanum, lutetium, gadolinium, and terbium; at least one second element selected from the group consisting of aluminum, gallium, and scandium, the second element including at least aluminum; and cerium.

(13) The method for manufacturing a wavelength conversion member according to any one of (9) to (12), where the phosphor has a median particle diameter corresponding to a volume cumulative frequency of 50% from a small diameter side in a volume cumulative particle size distribution in a range of 15 μm to 40 μm.

(14) The method for manufacturing a wavelength conversion member according to any one of (9) to (13), where the solvent contains at least one selected from the group consisting of dodecane, tridecane, tetradecane, pentadecane, and hexadecane.

(15) The method for manufacturing a wavelength conversion member according to any one of (9) to (14), where the substrate has a reflective surface formed of a material containing at least one selected from the group consisting of silver and aluminum, and the step of applying the phosphor composition onto the substrate includes applying the phosphor composition onto the reflective surface.

### EXAMPLES

The present disclosure will be described in detail below by using examples, but the present invention is not limited to these examples.

### Phosphor

As a phosphor, a rare earth aluminate phosphor having a theoretical composition represented by the following formula and having a median particle diameter of 24 μm and a rare earth aluminate phosphor having a median particle diameter of 31 μm were provided. Y₃Al₅O₁₂:Ce

### Substrate

As a substrate, a disk-shaped substrate formed of a metal containing aluminum and having a diameter of 33 mm and a thickness of 0.47 mm was provided. The specular reflectance of light having 450 nm wavelength on the reflective surface of the substrate was 89%.

### Example 1

To 100 parts by mass of the dimethyl silicone resin, 5 parts by mass of dodecane was added and mixed by a vacuum defoaming mixer. 400 parts by mass of a rare earth aluminate phosphor having a median particle diameter of 24 μm was added thereto and mixed by a vacuum defoaming mixer to obtain a phosphor composition. The obtained phosphor composition was applied onto a substrate by screen printing to form a phosphor composition layer. Thereafter, heat treatment was performed in an oven at 60° C. for 4 hours and then in an oven at 150° C. for 4 hours to form a wavelength conversion layer, whereby a wavelength conversion member of Example 1 was obtained.

### Examples 2 to 16 and Comparative Examples 1 and 2

Each wavelength conversion member was obtained in the same manner as in Example 1 except that the median particle diameter and the addition amount of the phosphor, and the type and the addition amount of the solvent were changed as illustrated in Table 1.

For the wavelength conversion member obtained as described above, the volume ratio of the phosphor to the binder in the wavelength conversion layer and the average thickness of the phosphor layer were measured as described below. The results are illustrated in Table 1.

### Volume Ratio Measurement

The density of the dimethyl silicone resin was set to 1.1 g/cm³, and the mass of the dimethyl silicone resin added to the phosphor composition was divided by the density of the dimethyl silicone resin to calculate the volumes of the dimethyl silicone resin in the phosphor composition. The density of the rare earth aluminate phosphor was set to 4.6 g/cm³, and the mass of the rare earth aluminate phosphor added to the phosphor composition was divided by the density of the rare earth aluminate phosphor to calculate the volume of the rare earth aluminate phosphor in the phosphor composition. The volume ratio of the phosphor to the binder in the formed wavelength conversion layer was calculated by dividing the volume of the rare earth aluminate phosphor by the volume of the dimethyl silicone resin contained in the phosphor composition.

### Average Thickness Measurement

The average thickness of the wavelength conversion layer was calculated by subtracting the arithmetic average value of the thickness of the substrate alone measured at six points from the arithmetic average value of the total thickness of the wavelength conversion layer and the substrate measured at six points. The total thickness of the wavelength conversion layer and the substrate and the thickness of the substrate alone were measured using a contact-type thickness measuring device.

### Relative Total Efficiency

For the wavelength conversion member obtained as described above, the fluorescence efficiency and the light collection efficiency in the light-emitting device were calculated as described below, and the total efficiency was calculated as the product of the fluorescence efficiency and the light collection efficiency. The total efficiency of each light-emitting device is illustrated in Table 1 as a relative total efficiency based on the total efficiency of the light-emitting device using the wavelength conversion member of Comparative Example 1 (100%).

For measuring the total efficiency, the light-emitting device as illustrated in FIG. 1 was provided. The wavelength conversion member was fixed to a rotation shaft of a motor and was in a state of being rotatable by the motor. Using the number of revolutions of the motor as 7200 rpm, fluorescence efficiency and light collection efficiency were measured in the following manner.

### Fluorescence Efficiency

For the wavelength conversion member of each Example and Comparative Example, a laser light with a wavelength of 450 nm from a laser diode was irradiated through a dichroic mirror with an intensity of 10 W and entered the wavelength conversion member so that the diameter of the incident light was 0.25 mm². The radiant flux of light emitted from the same surface as the surface on which the laser light was incident was separated by a dichroic mirror, and the intensity of the emitted light was measured using an integrating sphere. The fluorescence efficiency was obtained by dividing the intensity of the emitted light by the intensity of the incident light.

### Light Collection Efficiency

The wavelength conversion members of each Example and Comparative Example were irradiated with laser light by laser diodes having a wavelength of 455 nm. This irradiation was performed so that the light diameter of the incident light was 0.6 mm on the upper surface of the wavelength conversion member on which the laser light was incident. Subsequently, light emitted from the same surface as the upper surface of the wavelength conversion member on which the laser light was incident was measured by the following method. First, the emission luminance of light emitted from the wavelength conversion member of each Example and Comparative Example was measured by a luminance colorimeter, and the distance (mm) from the measurement center to two positions at which the luminance was 1/100 (1%) of the maximum luminance in the emission spectrum was measured as an absolute value with the position at which the maximum luminance was obtained in the obtained emission spectrum as the center (measurement center). Then, the sum of the distances (mm) from the measurement center to the two positions was calculated. This numerical value is referred to as “1% width” mm). As the numerical value of the 1% width is smaller, light is emitted in a narrower area, and light easily enters the secondary optical system, so that the light collection efficiency is increased. When the obtained numerical value of the 1% width is compared with the light collection efficiency (=emission output×100/fluorescence output) measured in a general actual secondary optical system, it is known that the light collection efficiency can be approximated by the following formula where the numerical value of the 1% width is x. Using this formula, the light collection efficiency was calculated from the measured value of the 1% width.

Light collection efficiency=−0.0012x²+0.1243x+58.783

TABLE 1

| | Phosphor | | Solvent | | | | |
|---|---|---|---|---|---|---|---|
| | Median | Mass | | Mass | Volume | | Relative |
| | particle | ratio | | ratio | ratio | Average | total |
| | diameter | (phosphor/ | | (solvent/ | (phosphor/ | thickness | efficiency |
| | (μm) | binder) | Type | binder) | binder) | (μm) | (%) |
| Comparative | 24 | 3.00 | — | 0 | 0.72 | 54 | 100.0 |
| Example 1 | | | | | | | |
| Example 1 | 24 | 4.00 | Dodecane | 0.05 | 0.96 | 59 | 102.9 |
| Example 2 | 24 | 4.00 | Dodecane | 0.05 | 0.96 | 65 | 105.2 |
| Example 3 | 24 | 4.00 | Dodecane | 0.05 | 0.96 | 84 | 108.2 |
| Example 4 | 24 | 4.00 | Tridecane | 0.05 | 0.96 | 60 | 108.1 |
| Example 5 | 24 | 4.00 | Tridecane | 0.05 | 0.96 | 85 | 109.9 |
| Example 6 | 24 | 4.00 | Tridecane | 0.05 | 0.96 | 129 | 104.9 |
| Comparative | 24 | 4.00 | Tridecane | 0.05 | 0.96 | 147 | 99.9 |
| Example 2 | | | | | | | |
| Example 7 | 24 | 4.00 | Hexadecane | 0.05 | 0.96 | 60 | 102.9 |
| Example 8 | 24 | 4.00 | Hexadecane | 0.05 | 0.96 | 65 | 105.7 |
| Example 9 | 24 | 4.00 | Hexadecane | 0.05 | 0.96 | 89 | 106.9 |
| Example 10 | 24 | 6.00 | Tridecane | 0.35 | 1.43 | 61 | 109.8 |
| Example 11 | 24 | 6.00 | Tridecane | 0.35 | 1.43 | 84 | 111.4 |
| Example 12 | 24 | 6.00 | Tridecane | 0.35 | 1.43 | 145 | 107.5 |
| Example 13 | 31 | 4.00 | Tridecane | 0.05 | 0.96 | 56 | 102.9 |
| Example 14 | 31 | 4.00 | Tridecane | 0.05 | 0.96 | 75 | 108.9 |
| Example 15 | 31 | 4.00 | Tridecane | 0.05 | 0.96 | 92 | 114.7 |
| Example 16 | 31 | 4.00 | Tridecane | 0.05 | 0.96 | 138 | 114.7 |

As illustrated in Table 1, when the volume ratio of the phosphor to the binder in the wavelength conversion layer was in a range of 0.75 to 1.45 and the average thickness of the wavelength conversion layer was in a range of 55 μm to 146 μm, the total efficiency of the light-emitting device according to Example was higher than that of the light-emitting device according to Comparative Example. As illustrated in Table 1, the total efficiency of the light-emitting device obtained by the manufacturing method according to Example was higher than that of the light-emitting device according to Comparative Example by forming a wavelength conversion layer having a thickness in a range of 55 μm to 146 μm using a phosphor composition containing a solvent having a boiling point of in a range of 200° C. to 300° C., dodecane (boiling point 216° C.), tridecane (boiling point 234° C.), and hexadecane (boiling point 287° C.) at a mass ratio of the solvent to the binder of in a range of 0.01 to 0.4 and a mass ratio of the phosphor to the binder of in a range of 3.15 to 6.05.

With respect to a typical wavelength conversion member obtained as described above, the ratio (cross-sectional ratio) of the sum of the particle cross-sectional areas of the phosphors to the cross-sectional area of the wavelength conversion layer was evaluated as described below. The results are illustrated in Table 2.

### Evaluation of Cross-sectional Ratio

A cross-sectional SEM image (lateral width: 640 μm) of the wavelength conversion layer obtained using a scanning electron microscope (SEM) was subjected to image analysis using image analysis software (ImageJ), and a binarization process was performed on particles in which the outer shape of the cross section of each phosphor could be confirmed in the cross-sectional SEM image. The cross-sectional areas of the binarized phosphor particles were integrated to calculate the total cross-sectional area of the phosphor. The cross-sectional area of the wavelength conversion layer was calculated by visually adjusting the positions of two parallel lines orthogonal to the thickness direction of the wavelength conversion layer so as to sandwich the wavelength conversion layer, and multiplying the vertical width of the wavelength conversion layer measured as the distance between the two parallel lines by a lateral width of 640 μm. Then, the total cross-sectional area of the phosphor was divided by the cross-sectional area of the wavelength conversion layer to calculate the cross-sectional ratio (%).

TABLE 2

| | | | | | | Vertical | | |
|---|---|---|---|---|---|---|---|---|
| | Phosphor | | Solvent | | | width of | | |
| | Median | Mass | | Mass | Volume | wavelength | Cross- | Relative |
| | particle | ratio | | ratio | ratio | conversion | sectional | total |
| | diameter | (phosphor/ | | (solvent/ | (phosphor/ | layer | ratio | efficiency |
| | (μm) | binder) | Type | binder) | binder) | (μm) | (%) | (%) |
| Comparative | 24 | 3.00 | — | 0 | 0.72 | 67 | 55.2 | 100.0 |
| Example 1 | | | | | | | | |
| Example 4 | 24 | 4.00 | Tridecane | 0.05 | 0.96 | 70 | 60.7 | 108.1 |
| Example 10 | 24 | 6.00 | Tridecane | 0.35 | 1.43 | 65 | 63.6 | 109.8 |

A wavelength conversion member according to the present disclosure and a light-emitting device including the wavelength conversion member can be used for a light source device for a projector, a lighting device, a backlight source for an automobile, a display, and a liquid crystal display, and the like.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing DESCRIPTION OF EMBODIMENT, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the DESCRIPTION OF EMBODIMENT, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A wavelength conversion member comprising:
a substrate; and
a wavelength conversion layer containing a binder and a phosphor, and disposed on the substrate, wherein
the wavelength conversion layer has a volume ratio of the phosphor to the binder in a range of 0.75 to 1.45, and an average thickness in a range of 55 μm to 146 μm.

2. A wavelength conversion member comprising
a substrate; and
a wavelength conversion layer containing a binder and a phosphor, and disposed on the substrate,
wherein in a cross section orthogonal to an arrangement surface of the wavelength conversion layer on the substrate, a ratio of a sum of a particle cross-sectional area of the phosphor to a cross-sectional area of the wavelength conversion layer is in a range of 56% to 70%, and
wherein an average thickness of the wavelength conversion layer is in a range of 55 μm to 146 μm.

3. The wavelength conversion member according to claim 1, wherein
the phosphor comprises a rare earth aluminate phosphor comprising:
at least one first element selected from the group consisting of yttrium, lanthanum, lutetium, gadolinium, and terbium;
at least one second element selected from the group consisting of aluminum, gallium, and scandium, the second element comprising at least aluminum; and
cerium.

4. The wavelength conversion member according to claim 3, wherein
the phosphor has a median particle diameter in a range of 15 μm to 40 μm.

5. The wavelength conversion member according to claim 1, wherein
the substrate has a reflective surface formed of a material containing at least one selected from the group consisting of silver and aluminum, and
the wavelength conversion layer is disposed on the reflective surface.

6. The wavelength conversion member according to claim 1, wherein
the binder contains a silicone resin.

7. A light-emitting device comprising
the wavelength conversion member according to claim 1,
a motor configured to rotate the wavelength conversion member; and
a light source configured to irradiate the wavelength conversion member with light.

8. A projector comprising
the light-emitting device according to claim 7,
an image display system; and
a projection optical system.

9. A method for manufacturing a wavelength conversion member, the method comprising:
applying a phosphor composition onto a substrate, wherein
the phosphor composition comprises a binder, a solvent, and a phosphor,
a boiling point of the solvent is in a range of 200° C. to 300° C.,
a mass ratio of the solvent to the binder is in a range of 0.01 to 0.4, and
a mass ratio of the phosphor to the binder is in a range of 3.15 to 6.05; and
heat-treating the phosphor composition applied onto the substrate to form a wavelength conversion layer.

10. The method for manufacturing a wavelength conversion member according to claim 9, wherein
the step of applying the phosphor composition onto the substrate comprises screen-printing the phosphor composition.

11. The method for manufacturing a wavelength conversion member according to claim 9, wherein
the step of heat-treating the phosphor composition comprises performing heat-treatment at less than 200° C.

12. The method for manufacturing a wavelength conversion member according to claim 9, wherein
the phosphor comprises a rare earth aluminate phosphor comprising:
at least one first element selected from the group consisting of yttrium, lanthanum, lutetium, gadolinium, and terbium;
at least one second element selected from the group consisting of aluminum, gallium, and scandium, and the second element comprising at least aluminum; and
cerium.

13. The method for manufacturing a wavelength conversion member according to claim 12, wherein
the phosphor has a median particle diameter corresponding to a volume cumulative frequency of 50% from a small diameter side in a volume cumulative particle size distribution in a range of 15 μm to 40 μm.

14. The method for manufacturing a wavelength conversion member according to claim 9, wherein
the solvent contains at least one selected from the group consisting of dodecane, tridecane, tetradecane, pentadecane, and hexadecane.

15. The method for manufacturing a wavelength conversion member according to claim 9, wherein
the substrate has a reflective surface formed of a material containing at least one selected from the group consisting of silver and aluminum, and
the step of applying the phosphor composition onto the substrate comprises applying the phosphor composition onto the reflective surface.
